(19) United States
(12) Patent Application Publication
(10) Pub. No.: US 2021/0390166 A1
(43) Pub. Date: Dec. 16, 2021

(54) ELECTRONIC COMPONENT FOR ELECTRONIC DEVICE WITH LOCKING FUNCTION AND UNLOCKING METHOD THEREOF

(71) Applicant: REALTEK SEMICONDUCTOR CORP., Hsinchu (TW)

(72) Inventors: Song Li, Hsinchu (TW); Hong-Hai Dai, Hsinchu (TW); Fu-Juan Cen, Hsinchu (TW)

(73) Assignee: REALTEK SEMICONDUCTOR CORP., Hsinchu (TW)

(21) Appl. No.: 17/039,322

(22) Filed: Sep. 30, 2020

(30) Foreign Application Priority Data
Jun. 10, 2020 (CN) 202010524497.2

(51) Int. Cl. G06F 21/32; G10L 17/24

(52) U.S. Cl. CPC G06F 21/32; G10L 17/24

(57) ABSTRACT

An electronic component for an electronic device with a locking function and an unlocking method thereof are provided. The unlocking method includes: receiving a first sound extraction request by a first processing circuit when the electronic device is in a locked mode; determining, by the first processing circuit, whether a first voice input signal is received after receiving the first sound extraction request; determining, by the first processing circuit when the first processing circuit receives the first voice input signal, whether first voice data included in the first voice input signal matches first preset voice data; and transmitting, by the first processing circuit, the first voice input signal to the second processing circuit when the first voice data matches the first preset voice data, to trigger the second processing circuit to determine whether second voice data included in the first voice input signal matches second preset voice data.

### CROSS-REFERENCE TO RELATED APPLICATION

This non-provisional application claims priority under 35 U.S.C. § 119(a) to Patent Application No. 202010524497.2 filed in China, P.R.C. on Jun. 10, 2020, the entire contents of which are hereby incorporated by reference.

### BACKGROUND

### Technical Field

The present disclosure relates to an electronic component for an electronic device with a locking function and an unlocking method thereof.

### Related Art

Face recognition unlock and fingerprint recognition unlock are common unlocking functions of an electronic device, but these two approaches still have some disadvantages that have not been overcome. Face recognition is prone to be affected by illumination conditions, and face recognition may fail when a user wears a mask. A human face may have high variability, and a contour of the human face is not stable. Therefore, a difference between images of human faces recognized at different angles is relatively large. In addition, human faces of different individuals may have high similarity, which also brings a large difficulty in face recognition.

Fingerprint recognition has a high requirement for environments and is sensitive to humidity and cleanness of a finger, and a recognition result may be affected when the finger carries dirt, oil stains, or water. When the user has few fingerprint features, or even no fingerprint, or low-quality fingerprints with desquamation or scars, the recognition may be difficult and result in a low rate of successful recognition. Therefore, it is relatively difficult in recognizing fingerprints of some special populations. Besides, each time when a fingerprint is pressed, a fingerprint stamp may be left on a fingerprint acquisition head, and there is a risk that these fingerprint stamps are used for copying fingerprints. The fingerprint recognition is based on user's direct contact and has a high requirement for operation specification.

### SUMMARY

In some embodiments, an unlocking method is provided, applied to an electronic device, the method including: receiving, by a first processing circuit, a first sound extraction request from a second processing circuit when the electronic device is in a locked mode; determining, by the first processing circuit, whether a first voice input signal is received from a sound extraction circuit after receiving the first sound extraction request; determining, by the first processing circuit when the first processing circuit receives the first voice input signal, whether first voice data included in the first voice input signal matches first preset voice data; and transmitting, by the first processing circuit, the first voice input signal to the second processing circuit when the first voice data matches the first preset voice data, to trigger the second processing circuit to determine whether second voice data included in the first voice input signal matches second preset voice data, and enable the second processing circuit to unlock the locked mode of the electronic device when the second voice data matches the second preset voice data.

In some embodiments, an electronic component is provided, applied to an electronic device with a locking function, and the electronic component includes a sound extraction circuit and a first processing circuit. The sound extraction circuit is configured to extract a first voice input signal when the electronic device is in a locked mode. The first processing circuit is coupled to the sound extraction circuit and is configured to receive a first sound extraction request from a second processing circuit of the electronic device, where the first processing circuit triggers, according to the first sound extraction request, the sound extraction circuit to extract the first voice input signal when the electronic device is in a locked mode, to receive the first voice input signal from the sound extraction circuit, determines whether first voice data included in the first voice input signal matches first preset voice data, and transmits the first voice input signal to the second processing circuit when the first voice data matches the first preset voice data, to trigger the second processing circuit to determine whether second voice data included in the first voice input signal matches second preset voice data, and enable the second processing circuit to unlock the locked mode of the electronic device when the second voice data matches the second preset voice data.

### BRIEF DESCRIPTION OF THE DRAWINGS

FIG. 1 is a schematic block diagram of an embodiment of an electronic device to which an unlocking method is applied according to the present disclosure.

FIG. 2 is a flowchart of an embodiment of the unlocking method according to the present disclosure.

FIG. 3 is another flowchart of an embodiment of the unlocking method according to the present disclosure.

FIG. 4A is another flowchart of an embodiment of the unlocking method according to the present disclosure.

FIG. 4B is a flowchart of an embodiment following FIG. 4A.

FIG. 5 is a schematic block diagram of an embodiment of the electronic device in FIG. 1.

### DETAILED DESCRIPTION

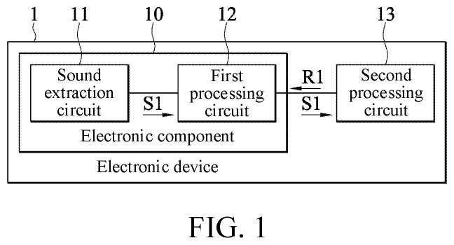

FIG. 1 is a schematic block diagram of an embodiment of an electronic device 1 to which an unlocking method is applied according to the present disclosure. Referring to FIG. 1, the electronic device 1 has a locking function, if a user of the electronic device 1 stops to operate the electronic device 1 for a preset period of time, the electronic device 1 may automatically enter a locked mode, or the user may actively trigger the electronic device 1 to enter a locked mode, in order to ensure the security of data stored in the electronic device 1. After the electronic device 1 enters the locked mode, the user cannot acquire data stored in the electronic device 1. Therefore, in order to unlock the electronic device 1, the user may input voice into the electronic device 1 to enable the electronic device 1 to receive a voice input signal. Voice data included in voice input signals given out by different users has uniqueness for identification, the electronic device 1 may perform the unlocking method of the present disclosure according to the uniqueness for identification of the voice input signal so as to unlock the locked mode of the electronic device 1. After the electronic device 1 is switched from the locked mode to unlocked, the user may acquire the data stored in the electronic device 1. As shown in FIG. 1, the electronic device 1 includes a sound extraction circuit 11, a first processing circuit 12, and a second processing circuit 13, where the first processing circuit 12 is coupled between the sound extraction circuit 11 and the second processing circuit 13. In some embodiments, the electronic device 1 may be a mobile phone, a tablet computer, a notebook computer, or a display.

In some embodiments, the second processing circuit 13 is a computation and control center of the electronic device 1, and the second processing circuit 13 may control the electronic device 1 to enter a locked mode or unlock the electronic device 1 that is in a locked mode. The first processing circuit 12 is a control center of voice input of the electronic device 1, that is, the first processing circuit 12 may trigger the sound extraction circuit 11 to extract the voice input signal. The voice input signal includes first voice data and second voice data that correspond to different phonetic components. When the sound extraction circuit 11 extracts the voice input signal, the first voice data and the second voice data may be processed by the first processing circuit 12 and the second processing circuit 13 respectively. The first processing circuit 12 may perform a processing procedure and a recognition procedure of the first voice data, and the second processing circuit 13 may perform a processing procedure and a recognition procedure of the second voice data. The first processing circuit 12 and the second processing circuit 13 may collaborate with each other to decide whether to unlock the electronic device 1 that is in the locked mode according to the voice input signal.

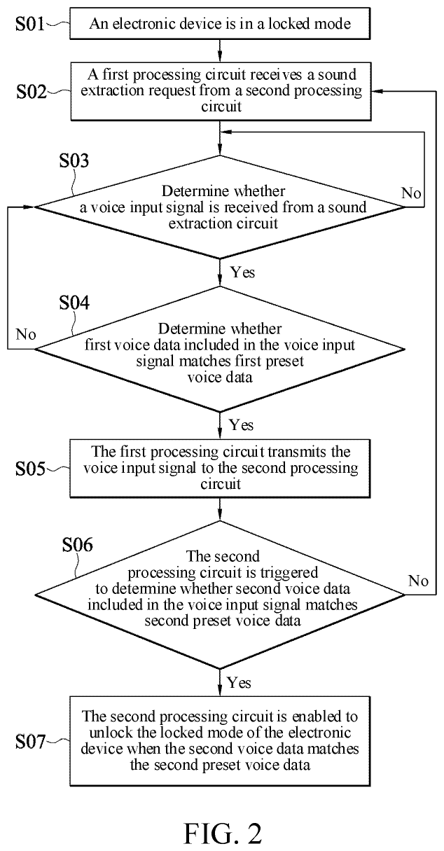

Referring to FIG. 1 and FIG. 2 together, FIG. 2 is a flowchart of an embodiment of the unlocking method according to the present disclosure. When the electronic device 1 is in a locked mode (step S01), the second processing circuit 13 transmits a first sound extraction request R1 to the first processing circuit 12, the first processing circuit 12 receives the first sound extraction request R1 from the second processing circuit 13 (step S02), to trigger, when the electronic device 1 is in the locked mode, the sound extraction circuit 11 to extract, according to the first sound extraction request R1, a voice input signal (hereinafter referred to as a first voice input signal S1) inputted by the user in its surrounding. After the sound extraction circuit is triggered, the first processing circuit 12 waits to receive the extracted first voice input signal S1 transmitted by the sound extraction circuit 11, and the first processing circuit 12 determines whether the first voice input signal S1 is received from the sound extraction circuit 11 (step S03). When the user produces a voice input signal in the surrounding environment of the electronic device 1, the sound extraction circuit 11 may extract the first voice input signal S1. The sound extraction circuit 11 then transmits the first voice input signal S1 to the first processing circuit 12, and the first processing circuit 12 determines whether the first voice input signal S1 is received (a determining result is “yes”). The first processing circuit 12 then determines whether first voice data included in the first voice input signal S1 matches preset voice data (hereinafter referred to as first preset voice data) pre-stored for comparison (step S04). When a determining result is that the first voice data matches the first preset voice data (the determining result is “yes”), the first processing circuit 12 transmits the first voice input signal S1 to the second processing circuit 13 (step S05).

After the second processing circuit 13 receives the first voice input signal S1, the second processing circuit 13 is triggered to determine whether second voice data included in the first voice input signal S1 matches another preset voice data (hereinafter referred to as second preset voice data) pre-stored for comparison (step S06). When a determining result is that the second voice data matches the second preset voice data (the determining result is “yes”), the second processing circuit 13 unlocks the locked mode of the electronic device 1 (step S07).

Based on the foregoing embodiment, compared with the fingerprint or face recognition unlocking method, use the voice unlocking method of the present disclosure to unlock the electronic device 1 may reduce the influence of the environment factors and focus on the uniqueness for identification of the voice data according to voice input signals provided by different people through speaking. By distinguishing distinct voice data that varies from person to person in the voice input signals, only the user can unlock the electronic device 1, thereby improving the security of the electronic device 1. In addition, it is convenient to acquire the voice input signal, and a case that the user wears a mask will not affect the voice data included in the voice input signal, so that the costs and the computation workload consumed by acquiring the voice input signal and performing voice data comparison are fewer than those of the fingerprint and face recognition.

In some embodiments, in step S03, when the first processing circuit 12 determines that the first voice input signal S1 is not received (the determining result is “no”), the first processing circuit 12 continues to wait for the first voice input signal S1.

In some embodiments, the second processing circuit 13 may be a central processing unit (CPU) or a system on chip (SOC) of the electronic device 1, the first processing circuit 12 may be a controller included in an independent sound card or audio chip of the electronic device 1, and a connection wire between the first processing circuit 12 and the second processing circuit 13 may be a universal serial bus (USB), a serial peripheral interface (SPI), or an inter-integrated circuit (I2C) bus. In this configuration, a computing capability of the second processing circuit 13 is higher than a computing capability of the first processing circuit 12, and the second processing circuit 13 may process voice input signals that are more complicated and with better computing capability than the first processing circuit 12. For example, the first processing circuit 12 may perform determining on comparison between voice keyword data, and the second processing circuit 13 may perform determination on comparison between voiceprint data. In some embodiments, the voice keyword data is a combination of language and text. For example, the language may be a language family (for example, Chinese, English, or Japanese) of various countries, and the text may be formed by one or more words (for example, “unlock” and “unlock screen”); and the voiceprint data is a voice feature peculiar to a creature, and the voiceprint data is different for each creature. Generally, the computation workload of acquiring the voiceprint data and performing comparison is higher than the computation workload of acquiring the voice keyword data and performing comparison.

According to the foregoing configuration, the first voice data included in the first voice input signal S1 may correspond to voice keyword data, and the second voice data included in the first voice input signal S1 may correspond to voiceprint data. That is, in step S04, after receiving the first voice input signal S1, the first processing circuit 12 acquires the first voice data that is the voice keyword data included in the first voice input signal S1, and determines whether the first voice data matches the first preset voice data (the data content is also voice keyword data); and in step S06, after receiving the first voice input signal S1, the second processing circuit 13 acquires the second voice data that is voiceprint data included in the first voice input signal S1, and determines whether the second voice data matches the second preset voice data (the data content is also voiceprint data). In short, the first processing circuit 12 performs determining on a voice keyword in the first voice input signal S1, and the second processing circuit 13 performs determining on a voiceprint of the user in the first voice input signal S1.

In some embodiments, the sound extraction circuit 11 may be a microphone device built in the electronic device 1. Alternatively, the sound extraction circuit 11 may be different from the foregoing built-in microphone device and may be a microphone device independently disposed in an independent interface card or an independent chipset. If the sound extraction circuit 11 is the foregoing independently disposed microphone device, the sound extraction circuit 11 and the first processing circuit 12 may be integrated together on the independent interface card or the independent chipset. In other words, the sound extraction circuit 11 and the first processing circuit 12 may be integrated into an electronic component 10 in the electronic device 1, namely, the electronic device 1 includes the electronic component 10 and the second processing circuit 13, and the electronic component 10 is coupled to the second processing circuit 13 to trigger the second processing circuit 13 to unlock the electronic device 1.

In some embodiments, in step S04, when the first processing circuit 12 determines that the first voice data which is the voice keyword data included in the first voice input signal S1 fail to match the pre-stored first preset voice data, the second processing circuit 13 does not unlock the electronic device 1, and the first processing circuit 12 may return to step S03 to determine whether a second voice input signal that is extracted and transmitted by the sound extraction circuit 11 is received. When a determining result of the first processing circuit 12 is that the second voice input signal is received, the first processing circuit 12 performs step S04, to determine whether voice data (hereinafter referred to as third voice data) included in the second voice input signal matches the pre-stored first preset voice data, where the third voice data and the first voice data correspond to the same voice keyword data. That is, the first processing circuit 12 may repeat step S03 and step S04, and not enter step S05 until it is determined that a voice input signal matching a correct voice keyword is received, but the present disclosure is not limited thereto. In some embodiments, a quantity of tries that the first processing circuit 12 repeats step S03 and step S04 is limited.

In some embodiments, in step S06, when the second processing circuit 13 determines that the second voice data which is the voiceprint data included in the first voice input signal S1 fail to match the pre-stored second preset voice data, the second processing circuit 13 does not unlock the electronic device 1. The second processing circuit 13 may retransmit a sound extraction request to the first processing circuit 12, and the first processing circuit 12 performs step S02 and step S03 to determine whether a third voice input signal that is extracted and transmitted by the sound extraction circuit 11 is received. When a determining result of the first processing circuit 12 is that the third voice input signal is received, the first processing circuit 12 performs step S04 to determine whether voice data (hereinafter referred to as fourth voice data) included in the third voice input signal matches the pre-stored first preset voice data, where the fourth voice data and the first voice data correspond to the same voice keyword data. That is, if the second processing circuit 13 does not receive a voice input signal matching a correct voiceprint, the first processing circuit 12 may perform determining on the voice keyword again.

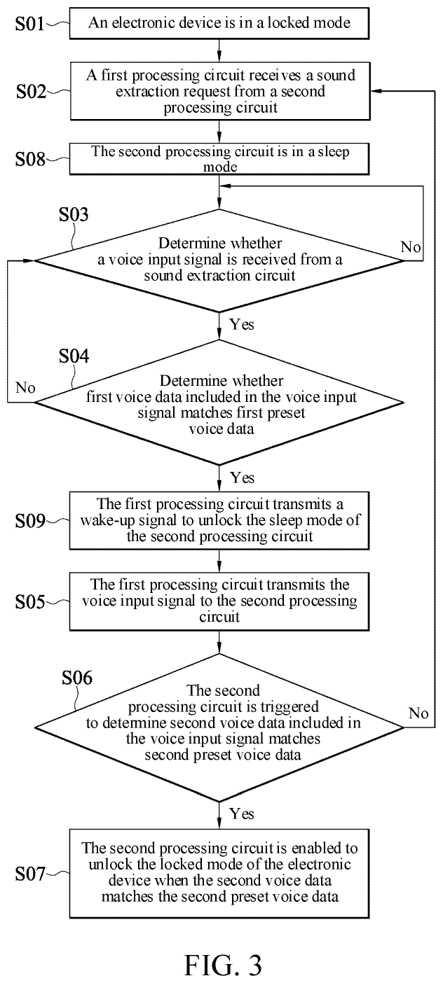

In some embodiments, the second processing circuit 13 includes a working mode and a sleep mode. After the second processing circuit 13 enters a locked mode and is idle for a period of time, the second processing circuit 13 may switch from the working mode to the sleep mode, and the second processing circuit 13 may reduce power consumed for operation in the sleep mode. To be specific, referring to FIG. 3, FIG. 3 is another flowchart of an embodiment of the unlocking method according to the present disclosure. After transmitting the first sound extraction request R1 in step S02, the second processing circuit 13 may switch from the working mode to the sleep mode (step S08). That is, when the first processing circuit 12 performs step S03, the second processing circuit 13 is in the sleep mode.

In addition, after the first processing circuit 12 performs step S04 and a determining result is that voice data (including the first voice data, the third voice data, and the fourth voice data) matches the first preset voice data (including a corresponding voice keyword) (means the determining result is “yes”), the first processing circuit 12 transmits a wake-up signal to unlock the sleep mode of the second processing circuit 13 (step S09) and the second processing circuit 13 switches from the sleep mode to the working mode. The first processing circuit 12 continues to perform step S05 to transmit the first voice input signal S1 (or the second voice input signal, or the third voice input signal) to the second processing circuit 13 when the second processing circuit 13 is in the working mode, in order to enable the second processing circuit 13 to compare the voiceprint data in the first voice input signal S1 (or the second voice input signal, or the third voice input signal) and the second preset voice data (including a corresponding voiceprint) in the working mode. On the other hand, when a determining result generated after the first processing circuit 12 performs step S04 is “no”, the first processing circuit 12 does not wake up the second processing circuit 13 that is in the sleep mode. That is, the first processing circuit 12 does not transmit the wake-up signal to the second processing circuit 13.

It should be understood that, in the foregoing embodiment, the first processing circuit 12 and the second processing circuit 13 determine whether the voice data in the voice input signal matches the preset voice data or not is not based on an absolute standard. Because comparison algorithms, user settings, or system tolerances used by the first processing circuit 12 and the second processing circuit 13 may be different, determination standards of the first processing circuit 12 and the second processing circuit 13 may be adjustable. For example, a determination standard including a tolerance value may be set according to a subtle voiceprint difference caused by changes of physical conditions of the user. However, the present disclosure is not limited thereto.

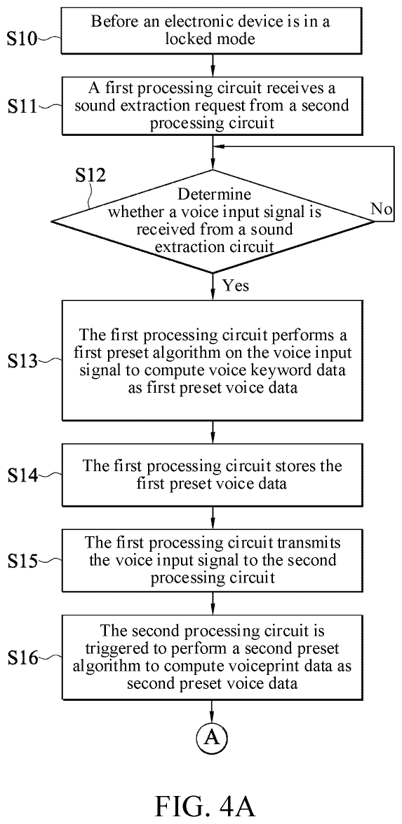

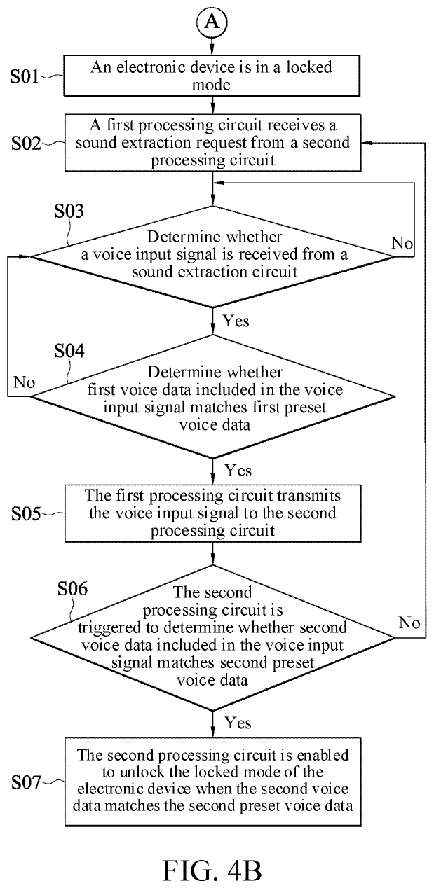

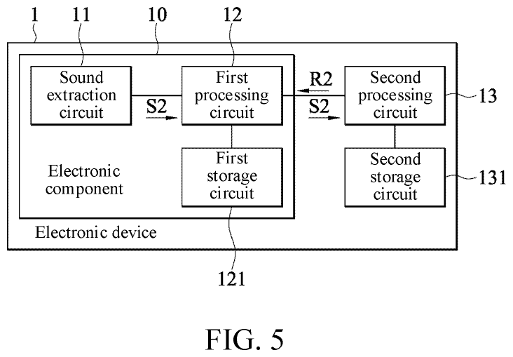

In some embodiments, refer to FIG. 4A and FIG. 4B together. Before step S01 (as shown in FIG. 4B), namely, before the electronic device 1 is operated in the locked mode (step S10 as shown in FIG. 4A), the user may first perform a registration procedure, and register voice keyword data and voiceprint data of a voice input signal in the electronic device 1. In the registration process, the second processing circuit 13 transmits a second sound extraction request R2 (referring to FIG. 5) to the first processing circuit 12, and the first processing circuit 12 receives the second sound extraction request R2 from the second processing circuit 13 (step S11), to trigger the sound extraction circuit 11 to extract, according to the second sound extraction request R2, a fourth voice input signal S2 inputted by the user in the surrounding environment. In this case, the first processing circuit 12 starts to wait to receive the fourth voice input signal S2 that is extracted and transmitted by the sound extraction circuit 11. After the sound extraction circuit 11 extracts the fourth voice input signal S2, the sound extraction circuit 11 transmits the fourth voice input signal S2 to the first processing circuit 12. When the sound extraction circuit 11 does not extract the fourth voice input signal S2, the first processing circuit 12 continues to wait to receive the fourth voice input signal S2 that is extracted and transmitted by the sound extraction circuit 11.

When the first processing circuit 12 waits to receive the fourth voice input signal S2 that is extracted and transmitted by the sound extraction circuit 11, namely, the first processing circuit 12 determines whether the fourth voice input signal S2 is received from the sound extraction circuit 11 (step S12), and when the first processing circuit 12 determines that the fourth voice input signal S2 is received (a determining result is “yes”), the first processing circuit 12 performs a first preset algorithm on the fourth voice input signal S2 to compute voice keyword data of the fourth voice input signal S2 as the first preset voice data (step S13). The first preset algorithm may include preprocessing, a Mel-scale Frequency Cepstral Coefficient (MFCC) algorithm, and a training model, to filter unnecessary noise in the fourth voice input signal S2 out, and generate a plurality of feature values according to Discrete Cosine Transform (DCT) in the MFCC algorithm. The voice keyword data of the fourth voice input signal S2 may be computed as the first preset voice data after several model training cycles are performed on the plurality of feature values.

In some embodiments, the first processing circuit 12 may transmit the fourth voice input signal S2 to the second processing circuit 13 (step S15) after receiving the fourth voice input signal S2. After receiving the fourth voice input signal S2, the second processing circuit 13 performs a second preset algorithm on the fourth voice input signal S2 to compute voiceprint data of the fourth voice input signal S2 as the second preset voice data (step S16). The representation form of a voiceprint varies from person to person, and the complexity of processing a voiceprint is higher than the complexity of processing a keyword. Therefore, the computation workload of the second preset algorithm is higher than the computation workload of the first preset algorithm. The second preset algorithm further includes a training model performed on the voiceprint of the fourth voice input signal S2, and the voiceprint data of the fourth voice input signal S2 may be computed as the second preset voice data after a plurality of times of model training are performed.

In some embodiments, referring to FIG. 5, the electronic device 1 may include a first storage circuit 121, and the first storage circuit 121 is connected to the first processing circuit 12. The first processing circuit 12 may store the computed first preset voice data in the first storage circuit 121 (step S14) for use when the first processing circuit 12 determines and compares voice input signals in step S04. Moreover, as shown in FIG. 5, the electronic device 1 may further include a second storage circuit 131, and the second storage circuit 131 is connected to the second processing circuit 13. The second processing circuit 13 may store the computed second preset voice data in the second storage circuit 131 for use when the second processing circuit 13 determines and compares voice input signals in step S06. After the second processing circuit 13 stores the second preset voice data, the user completes registration of the voice keyword data and the voiceprint data in the electronic device 1. Therefore, after the registration, when the electronic device 1 is in the locked mode, the electronic device 1 may perform step S01 to step S07 according to the first preset voice data and the second preset voice data that are stored, to unlock the locked mode of the electronic device 1.

The electronic device 1 of the present disclosure is not limited to the foregoing embodiments. In some other embodiments, the computing capability of the first processing circuit 12 is higher than the computing capability of the second processing circuit 13. In this case, the first processing circuit 12 can process voice input signals that are more complicated and with a higher computation workload than the second processing circuit 13 can. For example, because the computation workload of acquiring the voiceprint data is higher than the computation workload of acquiring the voice keyword data, in this case, the first processing circuit 12 determines the comparison between voiceprint data and the second processing circuit 13 determines the comparison between voice keyword data.

Therefore, the first voice data included in the first voice input signal S1 (or the fourth voice data included in the third voice input signal, or the third voice data included in the second voice input signal) may correspond to voiceprint data, and the second voice data included in the first voice input signal S1 may correspond to voice keyword data. That is, in step S04, the first processing circuit 12 determines whether the first voice data (or the third voice data, or the fourth voice data) which is voiceprint data matches the second preset voice data which is also voiceprint data; and in step S06, the second processing circuit 13 determines whether the second voice data which is voice keyword data matches the first preset voice data which is also voice keyword data. In addition, in step S14, the first preset voice data stored in the first processing circuit 12 of the first storage circuit 121 is voiceprint data, and in step S16, the second preset voice data stored in the second processing circuit 13 of the second storage circuit 131 is voice keyword data.

In some embodiments, the first processing circuit 12 and the second processing circuit 13 may be microcontrollers (MCUs), central processing units (CPUs), application specific integrated circuits (ASICs), or embedded controllers (ECs). The first storage circuit 121 and the second storage circuit 131 may be external memories, solid state drives (SSDs), or read-only memories (ROMs). The sound extraction circuit 11 may be a circuit including a sound collection function, such as a circuit of a microphone.

To sum up, according to the voice unlocking method for unlocking an electronic device of the present disclosure, compared with the fingerprint or face recognition unlocking method, the environment factor can hardly affect the voice unlocking method. In addition, according to voice keyword data and voiceprint data of voice input signals provided by different people. It provides more flexibility for the user to input and set different voice keyword data. Since the voiceprint data has uniqueness for identification, only the user can unlock the electronic device, thereby improving the security of the electronic device. In addition, it is convenient to acquire the voice input signal, and a case that the user wears a mask will not affect the voice data included in the voice input signal, so that the costs and the computation workload consumed by acquiring the voice input signal and performing voice data comparison are fewer than those of the fingerprint and face recognition.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. An unlocking method, applied to an electronic device with a locking function, the method comprising:
receiving, by a first processing circuit, a first sound extraction request from a second processing circuit when the electronic device is in a locked mode;
determining, by the first processing circuit, whether a first voice input signal is received from a sound extraction circuit after receiving the first sound extraction request;
determining, by the first processing circuit when the first processing circuit receives the first voice input signal, whether first voice data comprised in the first voice input signal matches first preset voice data; and
transmitting, by the first processing circuit, the first voice input signal to the second processing circuit when the first voice data matches the first preset voice data, to trigger the second processing circuit to determine whether second voice data comprised in the first voice input signal matches second preset voice data, and enable the second processing circuit to unlock the locked mode of the electronic device when the second voice data matches the second preset voice data.

2. The unlocking method according to claim 1, further comprising:
determining, by the first processing circuit when the first voice data fails to match the first preset voice data, whether a second voice input signal is received from the sound extraction circuit; and
determining, by the first processing circuit when the first processing circuit receives the second voice input signal, whether third voice data comprised in the second voice input signal matches the first preset voice data, wherein the first voice data and the third voice data correspond to voice keyword data.

3. The unlocking method according to claim 1, further comprising:
determining, by the first processing circuit when the second voice data fails to match the second preset voice data, whether a third voice input signal is received from the sound extraction circuit; and
determining, by the first processing circuit when the first processing circuit receives the third voice input signal, whether fourth voice data comprised in the third voice input signal matches the first preset voice data, wherein the first voice data and the fourth voice data correspond to voice keyword data.

4. The unlocking method according to claim 1, wherein a computing capability of the second processing circuit is higher than a computing capability of the first processing circuit, the first voice data corresponds to voice keyword data, and the second voice data corresponds to voiceprint data.

5. The unlocking method according to claim 1, further comprising:
receiving, by the first processing circuit, a second sound extraction request from the second processing circuit before the electronic device is in the locked mode;
determining, by the first processing circuit, whether a fourth voice input signal is received from the sound extraction circuit after receiving the second sound extraction request;
performing, by the first processing circuit when the first processing circuit receives the fourth voice input signal, a first preset algorithm to extract voice keyword data of the fourth voice input signal as the first preset voice data;
storing, by the first processing circuit, the first preset voice data; and
transmitting, by the first processing circuit, the fourth voice input signal to the second processing circuit, to trigger the second processing circuit to perform a second preset algorithm to extract voiceprint data of the fourth voice input signal as the second preset voice data, wherein
a computation workload of the first preset algorithm is lower than a computation workload of the second preset algorithm.

6. The unlocking method according to claim 1, wherein a computing capability of the first processing circuit is higher than a computing capability of the second processing circuit, the first voice data corresponds to voiceprint data, and the second voice data corresponds to voice keyword data.

7. The unlocking method according to claim 1, further comprising:
transmitting, by the first processing circuit when the electronic device is in the locked mode and the second processing circuit is in a sleep mode, a wake-up signal to unlock the sleep mode of the second processing circuit after the first processing circuit determines that the first voice data matches the first preset voice data; and
transmitting, by the first processing circuit, the first voice input signal to the second processing circuit after the sleep mode of the second processing circuit is unlocked, to trigger the second processing circuit to determine whether the second voice data matches the second preset voice data.

8. An electronic component, applied to an electronic device with a locking function, the electronic component comprising:
a sound extraction circuit, configured to extract a first voice input signal when the electronic device is in a locked mode; and
a first processing circuit, coupled to the sound extraction circuit, and configured to receive a first sound extraction request from a second processing circuit of the electronic device, wherein the first processing circuit triggers, according to the first sound extraction request, the sound extraction circuit to extract the first voice input signal when the electronic device is in a locked mode, to receive the first voice input signal from the sound extraction circuit, determines whether first voice data comprised in the first voice input signal matches first preset voice data,
and transmits the first voice input signal to the second processing circuit when the first voice data matches the first preset voice data, to trigger the second processing circuit to determine whether second voice data comprised in the first voice input signal matches second preset voice data, and
enable the second processing circuit to unlock the locked mode of the electronic device when the second voice data matches the second preset voice data.

9. The electronic component according to claim 8, further comprising a storage circuit, wherein the storage circuit is configured to store the first preset voice data.

10. The electronic component according to claim 8, wherein the first processing circuit determines, when the first voice data fails to match the first preset voice data, whether a second voice input signal is received from the sound extraction circuit, and determines, when the first processing circuit receives the second voice input signal, whether third voice data comprised in the second voice input signal matches the first preset voice data, the first voice data and the third voice data correspond to voice keyword data.

11. The electronic component according to claim 8, wherein when the second voice data fails to match the second preset voice data, the first processing circuit determines whether a third voice input signal is received from the sound extraction circuit, and when the first processing circuit receives the third voice input signal, determines whether fourth voice data comprised in the third voice input signal matches the first preset voice data, the first voice data and the fourth voice data correspond to voice keyword data.

12. The electronic component according to claim 8, wherein a computing capability of the second processing circuit is higher than a computing capability of the first processing circuit, the first voice data corresponds to voice keyword data, and the second voice data corresponds to voiceprint data.

13. The electronic component according to claim 8, wherein the first processing circuit receives a second sound extraction request from the second processing circuit before the electronic device is in the locked mode, to determine whether a fourth voice input signal is received from the sound extraction circuit,
performs, when the first processing circuit receives the fourth voice input signal, a first preset algorithm to compute voice keyword data of the fourth voice input signal as the first preset voice data,
stores the first preset voice data, and
transmits the fourth voice input signal to the second processing circuit, to trigger the second processing circuit to perform a second preset algorithm to compute voiceprint data of the fourth voice input signal as the second preset voice data, wherein a computation workload of the first preset algorithm is lower than a computation workload of the second preset algorithm.

14. The electronic component according to claim 8, wherein a computing capability of the first processing circuit is higher than a computing capability of the second processing circuit, the first voice data corresponds to voiceprint data, and the second voice data corresponds to voice keyword data.

15. The electronic component according to claim 8, wherein the first processing circuit transmits, when the electronic device is in the locked mode and the second processing circuit is in a sleep mode, a wake-up signal to unlock the sleep mode of the second processing circuit after the first processing circuit determines that the first voice data matches the first preset voice data, and
transmits the first voice input signal to the second processing circuit after the sleep mode of the second processing circuit is unlocked, to trigger the second processing circuit to determine whether the second voice data matches the second preset voice data.
